(19) United States
(12) Patent Application Publication
(10) Pub. No.: US 2017/0008525 A1
(43) Pub. Date: Jan. 12, 2017

(54) INTELLIGENT VEHICLE MANAGEMENT SYSTEM

(71) Applicant: Sung-suk KO, Bucheon (KR)

(72) Inventor: Sung-suk KO, Bucheon (KR)

(21) Appl. No.: 15/200,490

(22) Filed: Jul. 1, 2016

(30) Foreign Application Priority Data
Jul. 9, 2015 (KR) 10-2015-0097830
Apr. 11, 2016 (KR) 10-2016-0044033

(51) Int. Cl. B60W 30/188; B60W 30/18; B60W 40/076; B60W 20/00

(52) U.S. Cl. CPC B60W 30/188; B60W 20/00; B60W 30/18072; B60W 30/18127; B60W 40/076; B60W 2510/18; B60W 2510/0638; B60W 2510/08; B60W 2550/12; B60W 2520/10

(57) ABSTRACT

Disclosed herein is a system capable of calculating and analyzing energy loss in each of elements that consume energy of a vehicle and of managing the safety diagnosis and the potential regeneration energy of the vehicle based on the calculated and analyzed energy losses. In accordance with the intelligent vehicle management system according to an embodiment of the present invention, whether a vehicle is normally controlled is derived. If an abnormal control is determined, a warning signal is output to the vehicle in order to notify a driver of the necessity for repair and maintenance or the engine torque of the vehicle is limited. Accordingly, an accident attributable to abnormal control can be prevented. Furthermore, the expected braking distance of a vehicle being driven is derived so that the control unit can control the vehicle to keep a safe distance between the vehicle and an adjacent vehicle. And the potential regeneration energy during deceleration is also calculated and gathered into a specific server, which is used for the design of power plant capacity or the calculation of auto tax depending on individual driver's energy abuse.

### CROSS REFERENCE TO RELATED APPLICATION

The present application claims the benefit of Korean Patent Application No. 10-2015-0097830 filed in the Korean Intellectual Property Office on 9 Jul. 2015 and Korean patent Application No. 10-2016-0044033 filed in the Korean Intellectual Property Office on 11 Apr. 2016, the entire contents of which are incorporated herein by reference.

### BACKGROUND OF THE INVENTION

1. Technical Field

The present invention relates to an intelligent vehicle management system and, more particularly, to a system capable of calculating and analyzing energy loss in each of elements that consume energy of a vehicle and of managing the safety diagnosis and the potential regeneration energy of the vehicle during deceleration based on the calculated and analyzed energy loss.

2. Description of the Related Art

In this modern society, many electronic control technologies are grafted together as a vehicle becomes electronic.

Furthermore, with the quantum leap of the Internet communication technology, there is a growing interest in intelligent vehicles, such as a connected vehicle capable of Internet access, communication between vehicles, and communication between a vehicle and a server using software installed on a vehicle, and a driverless vehicle capable of driving without a manipulation of a driver.

Prior to the advent of such an intelligent vehicle (e.g., a connected vehicle and a driverless vehicle) era, in order to construct traffic safety management or infrastructure, there is a need for a system for managing a vehicle by accurately deriving the driving state of the vehicle. For example, there will be a need for a system capable of control of a vehicle in which the safe distance between vehicles can be maintained by predicting whether a vehicle is normally controlled and the potential braking distance of vehicles, capable of predicting potential regeneration energy using deceleration kinetic energy of a vehicle, and capable of using energy loss for each element of a vehicle as big data.

The use of electronic and communication technologies applied to a vehicle so far, however, is limited to the collection of information, such as Internet access in a vehicle, the startup of a vehicle using remote control, the upgrade of software for a vehicle using remote control, location and driving information about a vehicle, the recognition of the distance between vehicles using sensors, and the recognition of a lane departure. Accordingly, the electronic and communication technologies are not sufficiently used to manage the driving state of a vehicle itself, that is, information about energy information about elements that consume energy from the engine to wheels, that is, information about a vehicle itself and the safety and energy management of the vehicle using the information.

### SUMMARY OF THE INVENTION

Accordingly, the present invention has been made keeping in mind the above problems occurring in the prior art, and an object of the present invention is to provide a system capable of analyzing energy loss in each of the elements of a vehicle and of deriving and managing the driving state of the vehicle.

An intelligent vehicle management system according to an embodiment of the present invention includes a driving information collection unit configured to collect driving information about at least one of a brake pedal signal, an acceleration pedal opening degree, a virtual acceleration pedal opening degree, an autocruise switch signal, an engine RPM, a turbine RPM, a vehicle speed, instant fuel consumption, a road gradient, a motor current, a motor voltage, and atmospheric pressure for a vehicle; a vehicle characteristic storage unit configured to store vehicle characteristic data regarding at least one of a torque converter characteristic curve (C-factor curve), a torque converter torque multiplication characteristic equation, vehicle weight, driving resistance, a gear ratio, a tire dynamic radius, friction torque for each gear, a braking force characteristics, an engine braking torque characteristic map for each gear, a braking target loss rate map, a motor efficiency map, power train moving system inertia, and a target deceleration slope for the vehicle; a calculation unit configured to calculate energy loss in each of elements of the vehicle based on the driving information and the vehicle characteristic data; and a derivation unit configured to derive information about at least one of whether the vehicle is normally controlled, an expected braking distance of the vehicle, and regeneration energy in a deceleration situation of the vehicle based on the driving information, the vehicle characteristic data, and at least one of a the values calculated by the operation unit.

In this case, the derivation unit may set a derivation mode of whether the vehicle is normally controlled as at least one of a first mode and a second mode based on the driving information about the vehicle.

In this case, the first mode may be set when the driving information of the vehicle is determined to be at least acceleration driving or cruise driving, and the second mode may be set when the driving information of the vehicle is determined to be at least idle during a stop or idle during deceleration. In this case, the derivation unit in the first mode may derive whether the vehicle is normally controlled based on a difference between the energy value inputted from a driving source to a power transmission system and the sum of loss energy in elements subsequent to the driving source.

In this case, the driving source may be an engine if the vehicle is a mode in which an engine is driven in an internal-combustion engine vehicle or a hybrid vehicle. The driving source may be a motor if the vehicle is driven by only a motor in an electric vehicle or a hybrid vehicle.

In this case, the derivation unit in the second mode may calculate a value according to a second mode normal control reference equation based on the values calculated by the calculation unit, and may derive whether the vehicle is normally controlled.

In this case, the second mode normal control reference equation may be represented to include at least transmission slip energy loss if the vehicle is a mode in which an engine is driven in an internal-combustion engine vehicle or a hybrid vehicle. The second mode normal control reference equation may be represented to include at least acceleration resistance energy loss and road gradient driving energy loss if the vehicle is driven by only a motor in an electric vehicle or a hybrid vehicle.

In this case, the expected braking distance of the vehicle may be derived by an expected braking distance reference equation represented to include at least rolling resistance, aerodynamic resistance, road gradient resistance, and an expected braking force of the vehicle.

In this case, the intelligent vehicle management system may further include a transmission/reception unit configured to receive the expected braking distance of an adjacent vehicle from the adjacent vehicle or a specific server. The derivation unit may derive expected braking force information required for braking based on the expected braking distance of the vehicle and a second expected braking distance received through the transmission/reception unit.

In this case, the derivation unit may set derivation mode for regeneration energy information of the vehicle as at least one of a natural coasting deceleration mode and a braking deceleration mode based on the driving information of the vehicle.

In this case, the natural coasting deceleration mode may be set when the driving information of the vehicle may be determined to be decelerated due to driving resistance without a brake signal. The braking deceleration mode may be set when the driving information of the vehicle may be determined to be decelerated due to braking by a braking force.

In this case, the derivation unit in the natural coasting deceleration mode may derive the regeneration energy information based on the target amount of power of a motor which can generate the predetermined target deceleration slope.

In this case, the derivation unit in the braking deceleration mode may derive the regeneration energy information based on at least one of the target amount of power of a motor and a braking target loss energy rate which can generate the predetermined target deceleration slope.

In this case, the intelligent vehicle management system may further include a control unit configured to control a motor system so that the amount of power generated by the motor converges on the target amount of power of the motor or to control a brake system so that a braking energy loss rate converges on the braking target energy loss rate.

In this case, the calculation unit may calculate at least one of fuel consumption in each element and a fuel consumption rate in each element based on the driving information and the vehicle characteristic data. The intelligent vehicle management system may further include a display unit configured to display the values calculated by the operation unit in order to guide a driver to economical driving.

An intelligent vehicle management server according to an embodiment of the present invention includes a transmission/reception unit configured to receive reception information including driving information, vehicle characteristic data, and at least one of energy loss in each element from a vehicle and a derivation unit configured to derive derivation information about at least one of whether the vehicle is normally controlled, an expected braking distance of the vehicle, and regeneration energy in the deceleration situation of the vehicle based on the reception information.

In this case, the transmission/reception unit may receive reception information including driving information, vehicle characteristic data, and at least one of energy loss in each element from each of a plurality of vehicles. The derivation unit may derive derivation information about at least one of whether the vehicle is normally controlled, an expected braking distance of the vehicle, and regeneration energy in the deceleration situation of the vehicle from each of the plurality of vehicles and to manage the derivation information.

In this case, the derivation unit may derive the design of a power plant capacity or an auto tax for environmental charges based on at least one of the reception information and the derivation information.

### BRIEF DESCRIPTION OF THE DRAWINGS

FIG. 1 is a diagram schematically showing an intelligent vehicle management system according to an embodiment of the present invention.

FIG. 2 is a diagram schematically showing the general configuration of the intelligent vehicle management system according to an embodiment of the present invention.

FIG. 3 is a typical diagram schematically showing an energy flow of a vehicle in accordance with an embodiment of the present invention.

FIG. 4 is a diagram illustrating a flowchart in which whether a vehicle is normally controlled in a first mode is determined in accordance with an embodiment of the present invention.

FIG. 5 is a diagram illustrating a flowchart in which whether a vehicle in a second mode is normally controlled in accordance with an embodiment of the present invention.

FIG. 6 is a conceptual diagram for illustrating the principle in which a safe distance between a vehicle A and an adjacent vehicle B can be maintained by the intelligent vehicle management system according to an embodiment of the present invention.

FIG. 7 is tables schematically showing the expected braking distances (e.g., a first expected braking distance and a second expected braking distance) of the vehicle A and the adjacent vehicle B depending on the speed and braking force of the vehicle A and the adjacent vehicle B.

FIG. 8a is a diagram showing an example in which fuel consumption for each element is displayed on a display unit in accordance with an embodiment of the present invention.

FIGS. 8b and 8c are diagrams showing examples in which images changed according to an economic driving state are displayed on the display unit in accordance with an embodiment of the present invention.

### DETAILED DESCRIPTION

The present invention is described more fully hereinafter with reference to the accompanying drawings, in which exemplary embodiments of the present invention are shown. As those skilled in the art would realize, the described embodiments may be modified in various different ways, all without departing from the spirit or scope of the present invention. In order to clarify a description of the present invention, a description of parts not related to the description is omitted, and the same reference numbers are used throughout the specification to refer to the same or like parts.

Terms used in this specification are briefly described, and embodiments of the present invention are then described in detail.

The terms used in this specification are common terms which are now widely used by taking into consideration functions in the present invention, but the terms may be changed depending on an intention of those skilled in the art, a use practice, or the advent of a new technology. Furthermore, in a specific case, some terms are randomly selected by the applicant. In this case, the meaning of a corresponding term is described in a corresponding part of a corresponding invention. Accordingly, terms used in this specification should not be defined simply based on their names, but should be defined based on their substantial meanings and contents over this specification.

In the entire specification, unless explicitly described to the contrary, the word “comprise” and variations, such as “comprises” or “comprising”, will be understood to imply the inclusion of stated elements but not the exclusion of any other elements. Furthermore, the term “ . . . unit” described in the specification means a unit for processing at least one function or operation, and the unit may be implemented by hardware or software or a combination of hardware and software. Furthermore, throughout this specification, when it is described that one part is “connected” to the other part, the one part may be “directly connected” to the other part or connected to the other part “with a third element interposed between the one part and the other part.”

Embodiments of the present invention are described in detail below with reference to the accompanying drawings.

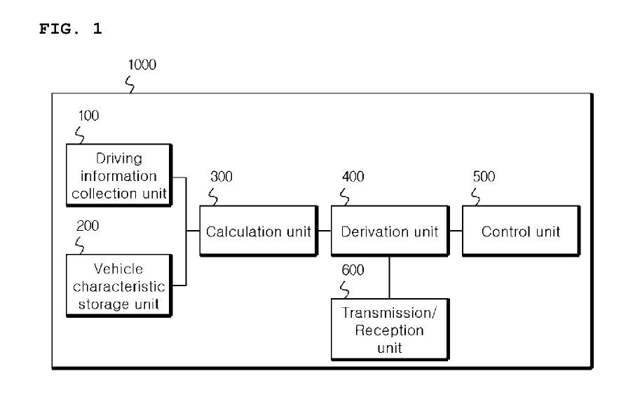

FIG. 1 is a diagram schematically showing an intelligent vehicle management system according to an embodiment of the present invention.

Referring first to FIG. 1, the intelligent vehicle management system may include a driving information collection unit 100 configured to collect driving information about at least one of a brake pedal signal, an acceleration pedal opening degree, an acceleration pedal opening degree, autocruise switch signal, an engine RPM, a turbine RPM, a vehicle speed, instant fuel consumption, a road gradient, a motor current, a motor voltage, and atmospheric pressure for a vehicle and a vehicle characteristic storage unit 200 configured to store vehicle characteristic data regarding at least one of a torque converter factor characteristic curve (C-factor curve), a torque converter torque multiplication characteristic equation, vehicle weight, driving resistance, a gear ratio, a tire dynamic radius, friction torque for each gear, a braking force characteristics, an engine braking targct torque characteristic map for each gear, a braking target loss rate map, a motor efficiency map, power train moving system inertia, and a target deceleration slope for the vehicle.

Furthermore, the intelligent vehicle management system may further include an calculation unit 300 configured to calculate energy loss in each of the elements of a vehicle based on the driving information and the vehicle characteristic data and a derivation unit 400 configured to derive derivation information about at least one of whether the vehicle is normally controlled, the first expected braking distance of the vehicle, and regeneration energy in the deceleration situation of the vehicle based on the driving information, the vehicle characteristic data, and at least one of a the values calculated by the operation unit 300.

Furthermore, the intelligent vehicle management system may further include a control unit 500 configured to output a warning signal to a vehicle or limit engine output torque of the vehicle based on a result of the derivation of whether the vehicle is normally controlled by the derivation unit 400.

Furthermore, the intelligent vehicle management system may further include a transmission/reception unit 600 configured to receive the second expected braking distance of an adjacent vehicle 50 from the adjacent vehicle 50 or a specific server.

In an embodiment, all of the driving information collection unit 100, the vehicle characteristic storage unit 200, the calculation unit 300, the derivation unit 400, the control unit 500, and the transmission/reception unit 600 of the intelligent vehicle management system 1000 according to an embodiment of the present invention may be implemented in a vehicle.

In some embodiments, the driving information collection unit 100, the vehicle characteristic storage unit 200, and the calculation unit 300 may be implemented in a vehicle, whereas the derivation unit 400, the control unit 500, and the transmission/reception unit 600 may be configured to be implemented in an intelligent vehicle management server 2000 capable of communicating with a vehicle and in this case the transmission/reception unit 600 is also implemented in a vehicle for communication, but the present invention is not necessarily limited thereto.

If the derivation unit 400, the control unit 500, and the transmission/reception unit 600 are implemented in the intelligent vehicle management server 2000, information, such as whether each vehicle is normally controlled, the expected braking distance of each vehicle, and regeneration energy of each vehicle, may be integrated and managed for each vehicle based on energy loss in each of the elements of a plurality of vehicles capable of communicating with the intelligent vehicle management server 2000.

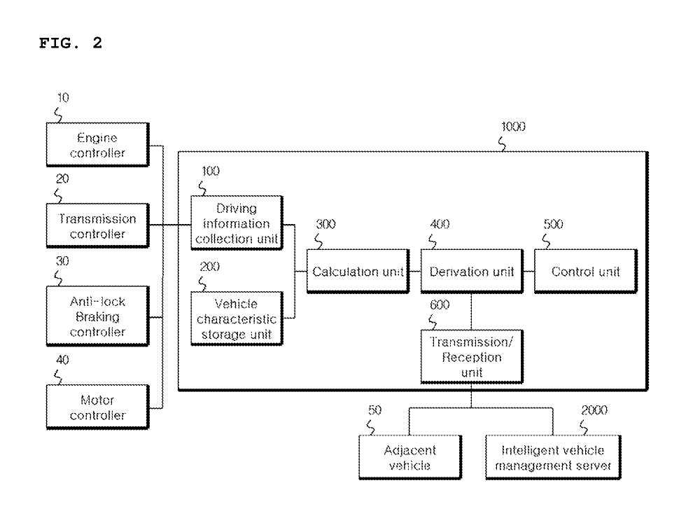

FIG. 2 is a diagram schematically showing the general configuration of the intelligent vehicle management system according to an embodiment of the present invention.

Referring to FIG. 2, the driving information collection unit 100 may receive information from the engine controller 10, transmission controller 20, anti-lock braking controller (ABS) 30, or motor controller 40 of a vehicle.

The intelligent vehicle management system 1000 according to an embodiment of the present invention is a system capable of deriving whether each of the elements of a vehicle is normally controlled, and may derive it based on energy lost in each of the elements of the vehicle.

In other words, the intelligent vehicle management system 1000 according to an embodiment of the present invention may derive whether each of the elements of a vehicle is normally controlled by determining that the vehicle is not normally controlled if energy that is actually lost is greater than or smaller than energy that needs to be lost in each of the elements of the vehicle or a combination of the elements when each of the elements of the vehicle is normally controlled.

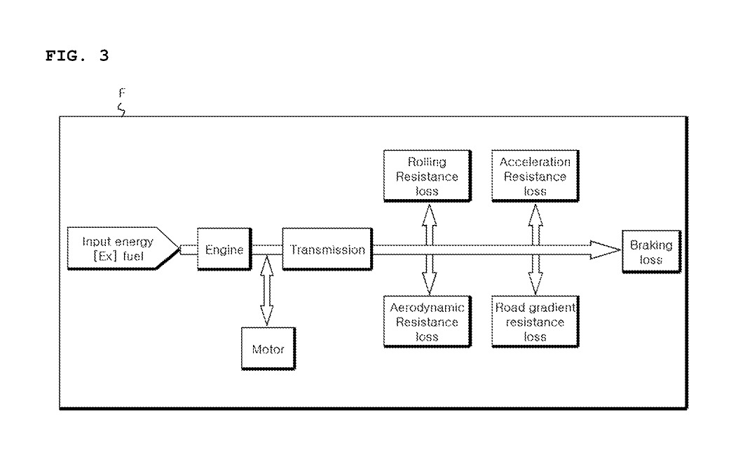

FIG. 3 is a typical diagram schematically showing an energy flow of a vehicle in accordance with an embodiment of the present invention.

Referring to the flow F of energy of FIG. 3, a calculated value on the left side of Equation 1 is the energy inputted to a vehicle. If each of the elements of the vehicle is normally controlled, a total sum of energy loss in each elements corresponding to a calculated value on the right side of Equation 1 may be consumed. In this case, Equation 1 has been represented based on an internal-combustion engine vehicle, but the present invention is not necessarily limited thereto. In the case of a hybrid vehicle, the following equation may be used if an internal-combustion engine (or an engine) normally operates.

Instant fuel consumption*fuel low-heating value=engine energy loss+transmission (or torque converter) slip energy loss+transmission gear friction energy loss+powertrain system inertia energy loss+vehicle acceleration resistance energy loss+vehicle road gradient driving energy loss+vehicle rolling resistance energy loss+vehicle aerodynamic resistance energy loss+braking energy loss+motor energy loss (1)

In Equation 1, the instant fuel consumption and each of the types of energy loss may be the values calculated for a specific calculation time task. For example, the distance that a vehicle has moved or the rotation angle of a shaft required to calculate loss energy means a value calculated for a calculation time task. In general, the calculation time task may be set to 0.1 second or more to 1.0 second or less.

The instant fuel consumption may be fuel consumption required for a specific calculation time task. In this case, the engine controller 10 may internally calculate the instant fuel consumption usually using an injector characteristic equation.

The fuel low-heating value is used to convert the amount of fuel into energy and vice versa. In the case of gasoline- and diesel-series fuel, the fuel low-heating value has a value of 40˜44 MJ/kg.

In this case, the energy loss may be calculated using a force*a moving distance, torque*a rotation angle or rotation inertia*angular acceleration, but the present invention is not necessarily limited thereto.

The engine energy loss may mean the sum of incomplete combustion loss energy, engine cooling loss energy, engine exhaust loss energy, engine pumping loss energy, engine friction loss energy, engine accessories (e.g., accessories, such as a power steering and an air conditioner compressor) energy loss, and engine inertia loss energy loss. In this case, the engine inertia less energy loss may be calculated using the inertia of an engine moving part*angular acceleration of a crankshaft.

The transmission (or torque converter) slip energy loss may be calculated by subtracting, output energy by the torque converter, from energy inputted to the torque converter of the transmission. Energy inputted to the torque converter may be calculated using a transmission (or torque converter) characteristic curve (C-factor curve)*engine RPM*engine RPM*input shaft rotation angle. Energy output by the torque converter may be calculated using torque converter input torque*a torque ratio*a shaft output rotation angle. In this case, the torque ratio is a value which may be read from a torque multiplication characteristic equation and is output torque/input torque, and may be a function of a speed ratio (i.e., turbine RMP/engine RPM).

The transmission gear friction energy loss may be calculated using friction torque for each gear*an output shaft rotation angle.

The powertrain system inertia energy loss may be calculated using the powertrain system inertia angular acceleration (in this case, the angular acceleration is the angular acceleration of the wheel).

The vehicle acceleration resistance energy loss may be calculated as ½ *M*(V₂²−V₁²). In this case, M is weight of a vehicle, V₁ and V₂ correspond to vehicle speed at the start point and end point of a calculation time task, respectively. For example, assuming that the calculation time task is 0.2 second, the acceleration resistance loss energy loss has a positive value if vehicle speed rises increases, and the acceleration resistance loss energy has a negative value if vehicle speed decreases.

The vehicle road gradient driving energy loss may be calculated using vehicle weight*acceleration of gravity*sin (a road gradient)*the distance that a vehicle has moved. For example, in uphill driving, the road gradient has a positive value, and thus the gradient driving energy loss has a positive value. In downhill driving, the road gradient has a negative value, and thus the gradient driving loss energy also has a negative value.

The vehicle aerodynamic resistance energy loss may be calculated using an aerodynamic resistance*the distance that a vehicle has moved. The aerodynamic resistance may be derived from a driving resistance curve equation (two terms: f0+f2*vehicle speed*vehicle speed or three terms: f0+f1*vehicle speed+f2*vehicle speed*vehicle speed) obtained through experiments. In this case, f0 may mean a rolling resistance, and f2*vehicle speed*vehicle speed (or f1*vehicle speed+f2*vehicle speed*vehicle speed in three terms) may mean an aerodynamic resistance. f0 and f2 (f0, f1 and f2 in three terms) may mean the coefficient of a driving resistance obtained by fitting experimental driving resistance data. The driving resistance data may be obtained by a so-called coast down test.

Aerodynamic resistance gets smaller as air density decreases according to an altitude. Accordingly, the aerodynamic resistance energy loss may be compensated by the correction of an altitude.

The aerodynamic resistance may be calculated using another method. As in Equation 2 below, the aerodynamic resistance may be calculated using a front projection area and an aerodynamic resistance coefficient.

Aerodynamic resistance=0.5*air density*vehicle speed*vehicle speed*an aerodynamic resistance coefficient*a front projection area (2)

The vehicle rolling resistance energy loss may be calculated by multiplying the value of the rolling resistance f0 by the distance that a vehicle has moved.

The braking energy loss may be calculated using a braking force*the distance that a vehicle has moved. In this case, brake line oil pressure increases in proportion to a force that a driver presses on the brake and then converges. The braking force is increased and then converged in proportion to such brake line oil pressure. That is, in a common driving situation in which a driver has not pressed on the brake, the braking energy loss is 0. In a situation in which a driver presses on the brake and the vehicle moves (e.g., in a sudden unintended acceleration situation or a deceleration situation), the braking energy loss has a value greater than 0.

The motor energy loss may be calculated in two ways as follows if information about a voltage and the amount of current that enter into and exit from a battery for a motor is given and the state of charge (SOC) of the battery is provided.

1. When the battery for the motor is charged with a current, it means that a current is generated through the motor. In this case, the motor functions as a resistor. At this time, the motor energy loss may be calculated by dividing a current*a voltage by efficiency of the motor and then integrating the calculation result for a calculation time task, and has a positive value. In this case, like another fuel consumption element, the motor may function as another fuel consumption element.

2. When a current exits from the battery for the motor, it means that energy is transferred to the vehicle through the motor as the engine. At this time, the motor energy loss may be calculated by multiplying a current*a voltage by efficiency of the motor and integrating the calculation result for a calculation time task, and has a negative value. In this case, the motor becomes another power source like an engine. In other words, when the value calculated as energy loss has a negative value, it means that energy is inputted to the powertrain system.

The derivation unit 400 may set derivation mode of whether a vehicle is normally controlled as one of a first mode and a second mode based on driving information for the vehicle.

The first mode may be set if the driving information of the vehicle corresponds to a normal driving condition for the vehicle (e.g., acceleration driving or cruise driving, that is, the state in which an acceleration pedal opening degree or a virtual acceleration pedal opening degree is greater than 0 without a brake signal) other than idle during a stop and idle during deceleration.

In this case, the second mode may be set if driving information for the vehicle is determined to be an idle situation. In this case, the idle situation may include an idle situation during a stop and an idle situation during deceleration. For example, if driving information for the vehicle is determined to be an idle situation, the idle situation may be at least one of the state in which it is not auto cruise mode and the acceleration pedal opening degree is 0, the state in which the brake signal is ON, and the state in which the virtual acceleration pedal opening degree (or a variable conforming to the acceleration pedal opening degree) used by the engine controller 10 is 0 in the case of a vehicle not having an acceleration pedal (e.g., an driverless vehicle).

The derivation unit 400 in the first mode may derive whether a vehicle is normally controlled based on the values calculated by the calculation unit 300. An example of the principle in which the derivation unit 400 in the first mode derives whether a vehicle is normally controlled is described below.

First, the derivation unit 400 in the first mode may calculate the sum of energy loss in elements subsequent to a driving source based on the values calculated by the operation unit 300. In this case, the “driving source” may mean an engine in the case of an internal-combustion engine vehicle or may mean an engine in the case of mode in which a vehicle is driven by an internal-combustion engine (or an engine) in the case of a hybrid vehicle. The driving source may mean a motor in the case of an electric vehicle or may mean a motor in the case of mode in which a vehicle is purely driven by the motor in the case of a hybrid vehicle.

In this case, the “elements subsequent to the driving source” means the elements that consume the energy inputted by the driving source. In the case of a hybrid vehicle with its engine active, the motor could be used as an element for providing electric power to a vehicle, but is treated as an element subsequent to the transmission, for convenience of description.

More specifically, the “sum of loss energy in elements subsequent to the driving source” may be divided and represented as following depending on the type of driving source.

1. In mode in which an internal-combustion engine (or an engine) is driven in an internal-combustion engine vehicle or a hybrid vehicle,

A total sum of energy losses after the engine=transmission(or torque converter)slip energy loss+transmission gear friction loss energy+powertrain inertia energy loss+vehicle acceleration resistance energy loss+vehicle road gradient driving energy loss+vehicle rolling resistance energy loss+vehicle aerodynamic resistance energy loss+motor energy loss, where in a hybrid vehicle which does not have torque converter, transmission slip energy loss is zero.

2. In mode in which a vehicle is purely driven by a motor in the case of an electric vehicle and a hybrid vehicle (in the case of the electric vehicle, in order to reduce the number of rotations of the motor, a speed reducer could be used instead of the transmission used in the internal-combustion engine),

A total sum of energy losses after the engine=speed reducer gear friction energy loss+powertrain system inertia energy loss+vehicle acceleration resistance loss energy+vehicle road gradient driving energy loss+vehicle rolling resistance loss energy+vehicle aerodynamic resistance energy loss

Furthermore, the derivation unit 400 in the first mode derives whether a vehicle is normally controlled based on a difference between the value of energy inputted from a driving source to a powertrain system and the sum of energy losses in elements subsequent to the driving source. In other words, the derivation unit 400 in the first mode derives whether the vehicle is normally controlled using the concept in which energy inputted from the driving source to the powertrain system needs to be approximate to the sum of energy losses in elements subsequent to the driving source if the vehicle is normally controlled.

In this case, the “energy inputted from a driving source to a powertrain system” may be divided and represented as follows depending on the type of driving source.

1. In the case of an internal-combustion engine vehicle and mode in which an internal-combustion engine (or an engine) is driven in the case of a hybrid vehicle,

Energy inputted from the engine to the powertrain system=instant fuel consumption*a fuel low-heating value*engine efficiency; or

Energy inputted from the engine to the powertrain system=output torque by the engine*a rotation angle in an input axis to powertrain system

2. In the case of an electric vehicle and mode in which a vehicle is purely driven by the motor in the case of a hybrid vehicle,

Energy inputted from the motor to the powertrain system=a value obtained by integrating(a motor current*a motor voltage*motor efficiency) for a calculation time task

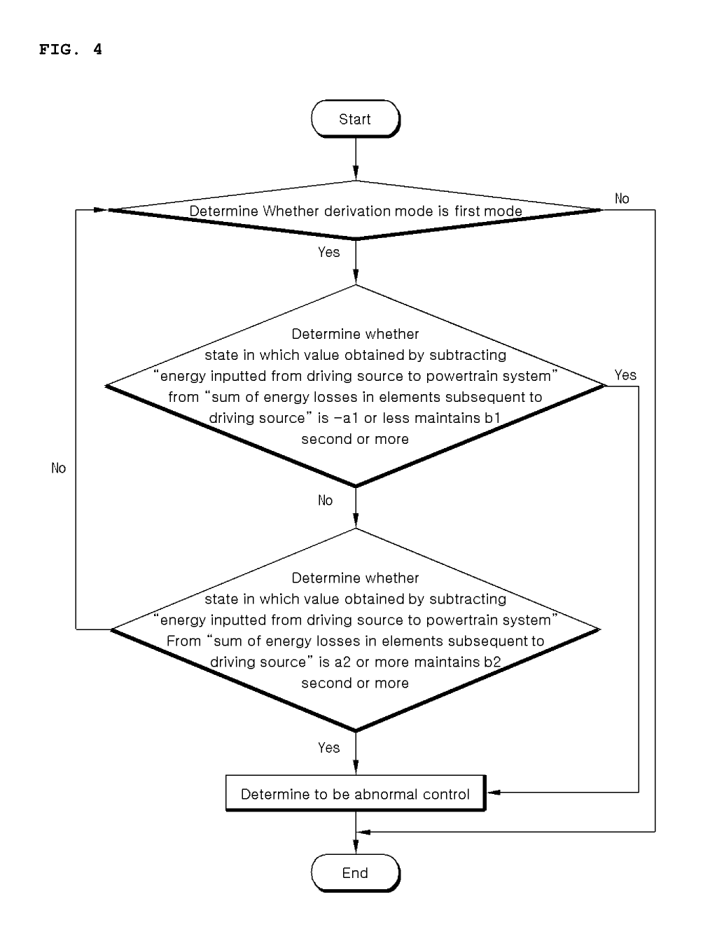

FIG. 4 is a diagram illustrating a flowchart in which whether a vehicle is normally controlled in the first mode is determined in accordance with an embodiment of the present invention.

Referring to FIG. 4, the derivation of whether a vehicle is normally controlled by the derivation unit 400 in the first mode may be performed by taking the following sequence as an example.

1. Determine whether the derivation mode is the first mode

2. Determine whether the state in which a value obtained by subtracting “energy inputted from a driving source to a powertrain system” from the “sum of energy losses in elements subsequent to the driving source” is −a1 or less maintains b1 second or more

3. Determine whether the state in which a value obtained by subtracting “energy inputted from a driving source to a powertrain system” from the “sum of energy losses in elements subsequent to the driving source” is a2 or more maintains b2 second or more

4. If the determination 2 or the determination 3 is satisfied, abnormal control is diagnosed

In this case, a criterion for the determination 2 and the determination 3 is based on a premise that an abnormal control possibility is present.

Furthermore, in the determinations, a1 or a2 corresponds to a reference value by which whether a difference between the “sum of energy losses in elements subsequent to the driving source” and “energy inputted from the driving source to the powertrain system” may be considered to be abnormal control is determined. In this case, a1 and a2 have a positive value.

Furthermore, in the determinations, b1 or b2 is means for filtering erroneous detection attributable to noise or a determination error, and may have a value between 0.1 second˜2 seconds.

The derivation unit 400 in the second mode may calculate the values according to at least one of the second mode normal control reference equations to be described later based on the values calculated by the operation unit 300, and may derive whether a vehicle is normally controlled.

In other words, the derivation unit 400 in the second mode may derive whether a vehicle is normally controlled using at least one of the plurality of second mode normal control reference equations.

The second mode normal control reference equation may be divided and represented as follows depending on the type of driving source.

1. In the case of an internal-combustion engine vehicle and mode in which an internal-combustion engine (or an engine) is driven in the case of a hybrid vehicle, the second mode normal control reference equation is represented, including at least a transmission (or torque converter) slip energy loss. In a hybrid vehicle which does not have torque converter, transmission slip energy loss is zero.

The second mode normal control reference equation 1=transmission slip energy loss

The second mode normal control reference equation 2=transmission slip energy loss+vehicle acceleration resistance energy loss

The second mode normal control reference equation 3=transmission slip energy loss+vehicle acceleration resistance energy loss+vehicle road gradient driving energy loss

The second mode normal control reference equation 4=transmission slip energy loss+vehicle acceleration resistance energy loss+braking energy loss

The second mode normal control reference equation 5=transmission slip energy loss+vehicle acceleration resistance energy loss+vehicle road gradient driving energy loss+braking energy loss

The second mode normal control reference equation 6=the sum of energy losses in elements subsequent to the engine except for motor energy loss=transmission slip energy loss+transmission gear friction energy loss+powertrain system inertia energy loss+vehicle acceleration resistance energy loss+vehicle road gradient driving energy loss+vehicle rolling resistance energy loss+vehicle aerodynamic resistance energy loss+braking energy loss

2. In the case of an electric vehicle and in mode in which a vehicle is purely driven by a motor in the case of a hybrid vehicle, the second mode normal control reference equation is represented to include at least acceleration energy loss and road gradient driving energy loss.

The second mode normal control reference equation 1=vehicle acceleration resistance energy loss+vehicle road gradient driving energy loss

The second mode normal control reference equation 2=vehicle acceleration resistance energy loss+vehicle road gradient driving energy loss+braking energy loss

The second mode normal control reference equation 3=speed reducer gear friction energy loss+powertrain system inertia energy loss+vehicle acceleration resistance energy loss+vehicle road gradient driving energy loss+vehicle rolling resistance energy loss+vehicle aerodynamic resistance energy loss+braking energy loss

If a vehicle is normally controlled, the derivation unit 400 in the second mode may derive whether the vehicle is normally controlled using the concept in which the values according to a second mode normal control reference equations that belongs to the plurality of second mode normal control reference equations and that is used to derive whether the vehicle is normally controlled does not deviate from a threshold of normal control/abnormal control.

In general, the engine controller 10 may collect information about the amount of fuel injected into the engine. The motor controller 40 may collect a current and a voltage applied to the motor. Furthermore, the engine controller 10 or the motor controller 40 takes proper safety measures if control corresponding to the collect information about the amount of fuel injected into the engine or the collected current and voltage applied to the motor is not performed.

In contrast, if engine controller 10 or motor controller 40 does not perceive the abnormal control of injection or current different from the scheduled one, sudden unintended acceleration may be generated because the injection of fuel or the application of a motor current much exceeding a numerical value to be scheduled to be controlled is performed.

In the present embodiment, the derivation unit 400 may calculate the energy loss of elements to which the energy from driving source has been supplied, and may derive normal control/abnormal control by comparison between the calculated energy loss and an energy loss when normal control is performed.

In this case, the “threshold of normal control/abnormal control” may be a value experimentally obtained in a vehicle development stage or a value that is learnt and updated in the derivation unit 400 in the second mode when a vehicle is a normal state while the vehicle is driven.

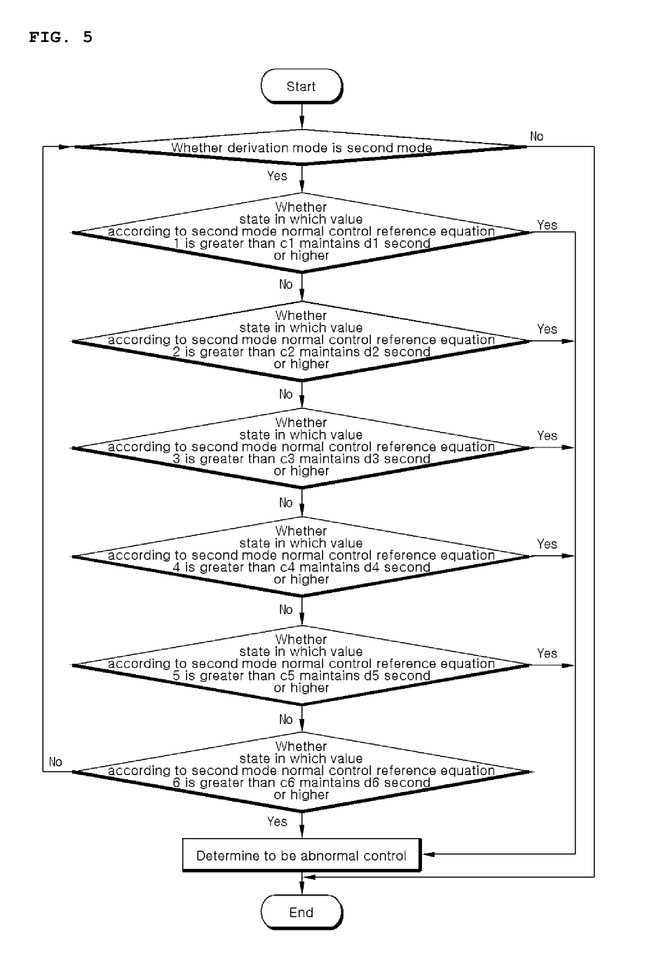

FIG. 5 is a diagram (a flowchart) illustrating the judgment of whether a vehicle in the second mode is normally controlled in accordance with an embodiment of the present invention.

A process for determining whether a vehicle is normally controlled in the second mode is hereinafter described based on mode in which an internal-combustion engine (or an engine) is driven in an internal-combustion engine vehicle and a hybrid vehicle, for convenience of description.

The derivation unit 400 in the second mode may derive whether the vehicle is normally controlled in the second mode using at least one of the plurality of second mode normal control reference equations (i.e., the second mode normal control reference equations 1 to 7). For example, in order to derive whether the vehicle is normally controlled in the second mode, only the second mode normal control reference equation 1 may be selected and used or all of the second mode normal control reference equations 1 to 7 may be selected and used. In the present embodiment, for convenience of description, it is assumed that all of the second mode normal control reference equations 1 to 7 are selected and used.

Referring to FIG. 5, the derivation unit 400 in the second mode may derive whether the vehicle is normally controlled as follows.

1. Whether the derivation mode is the second mode

2. Whether the state in which a value according to the second mode normal control reference equation 1 is greater than c1 maintains d1 second or higher

3. Whether the state in which a value according to the second mode normal control reference equation 2 is greater than c2 maintains d2 second or higher

4. Whether the state in which a value according to the second mode normal control reference equation 3 is greater than c3 maintains d3 second or higher

5. Whether the state in which a value according to the second mode normal control reference equation 4 is greater than c4 maintains d4 second or higher

6. Whether the state in which a value according to the second mode normal control reference equation 5 is greater than c5 maintains d5 second or higher

7. Whether the state in which a value according to the second mode normal control reference equation 6 is greater than c6 maintains d6 second or higher

8. If the derivation mode corresponds to at least one of the determination 2 to the determination 7, abnormal control is derived.

In this case, in the determinations, c1 to c6 may be the “threshold of normal control/abnormal control.”

Furthermore, in the determinations, the values d1 to d6 are means for filtering erroneous detection attributable to noise or a determination error, and may have a value between 0.1 second˜2 seconds.

If the derivation unit 400 derives the state in which the vehicle is not normally controlled (i.e., abnormal control), the control unit 500 may display that “abnormal control” is performed on the display unit of the vehicle using text, a symbol, or an image or may output a sound signal providing notification that “abnormal control” is performed through a sound unit. Furthermore, the control unit 500 may store vehicle driving information and the results of the analysis and calculation of energy in each of elements for a specific time prior to a point of time at which abnormal control is determined or for a specific time after the point of time at which abnormal control is determined, and may use the vehicle driving information and the results of the analysis and calculation of energy as data that facilitates the tracking and analysis of a cause of the abnormal control. To this end, the vehicle driving information and the results of the analysis and calculation of energy may be stored in temporary storage, that is, a so-called buffer and may be stored in permanent storage if the vehicle is determined to be in abnormal control.

Furthermore, if a vehicle according to the present embodiment is an internal-combustion engine vehicle, when the derivation unit 400 derives the state in which the vehicle is not normally controlled (i.e., abnormal control), the control unit 500 may take measures for blocking power inputted to an electronic throttle motor, limiting engine torque through the engine controller, or blocking the power delivery to the transmission by forcibly shifting from the R gear or D gear to the N gear or P gear through the transmission controller. If a vehicle according to the present embodiment is a hybrid vehicle, when the derivation unit 400 derives the state in which the vehicle is not normally controlled (i.e., abnormal control), the control unit 500 may limit or block power inputted to the motor or shut down system power required to drive the motor in addition to the measures of the internal-combustion engine vehicle. If a vehicle according to the present embodiment is an electric vehicle, when the derivation unit 400 derives the state in which the vehicle is not normally controlled (i.e., abnormal control), the control unit 500 may limit or block power inputted to the motor or shut down system power required to drive the motor.

In the intelligent vehicle management system 1000 according to an embodiment of the present invention, the derivation unit 400 may derive a first expected braking distance according to the expected braking force of a vehicle during driving based on driving information for the vehicle and vehicle characteristic data.

The first expected braking distance according to the expected braking force of the vehicle during driving may be calculated by accumulating Δ moving distance until the current Δ kinetic energy of the vehicle becomes 0 according to the expected braking force in Equations 4 and 5. In this case, Equation 4 is used in an internal-combustion engine vehicle and a hybrid vehicle, and Equation 5 is used in an electric vehicle.

1. In the case of an internal-combustion engine vehicle and a hybrid vehicle

|Δ kinetic energy (½*M*(V₂²−V₁²))|=(vehicle's rolling resistance+vehicle's aerodynamic resistance+vehicle's expected braking force+road gradient resistance)*Δ moving distance+engine braking torque*Δ engine output shaft rotation angle+gear friction torque*Δ gear output shaft rotation angle+motor's energy loss+powertrain inertia energy loss (4)

In Equation 4, the engine braking torque is a load applied to the engine if the engine and the transmission are connected directly (including a case where the engine and the transmission are connected in the slipped state, and may be experimentally calculated. If the engine and the transmission are not directly connected, the engine braking torque may have a value of 0.

2. In the case of an electric vehicle

|Δ kinetic energy (½*M*(V₂²−V₁²))|=(vehicle's rolling resistance+vehicle's aerodynamic resistance+vehicle's expected braking force+vehicle's road gradient resistance)*Δ moving distance+gear friction torque*Δ gear output shaft rotation angle+motor's less energy loss+powertrain system inertia energy loss (5)

In Equation 5, the vehicle's road gradient resistance has a positive value in an uphill slope and has a negative value in a downhill slope. Furthermore, the motor's energy loss has a positive value if a current is regenerated and has a negative value if the motor operates as a driving source. As Δ kinetic energy decreases, (½*M*(V₂²−V₁²)) becomes a negative value and may be subjected to absolute value processing so that the value on the right side of FIG. 5 always has a positive value.

Referring to Equations 4 and 5, the rolling resistance, the aerodynamic resistance, the engine braking torque, and the motor's regeneration output at the moment when deceleration is started are the values capable of being extracted through the driving information collection unit 100, the vehicle characteristic storage unit 200, and the calculation unit 300. In this case, assuming that a braking force has a fixed specific value, the vehicle's Δ moving distance for a calculation time task may be calculated as vehicle's deceleration average speed (V1+V2)/2*the calculation time task, where V2 is assumed to a certain proper value initially but has a converged value by iteration. The motor's energy loss may be calculated by integrating motor output (i.e., the motor's voltage*the motor's current)/motor efficiency) for a calculation time task. The powertrain inertia energy loss may be calculated by the powertrain inertia*a wheel's angular acceleration. As a result, since the terms on the right side are values that can be all calculated, vehicle's speed V2 after a calculation time task on the left side may also be calculated. Assuming that the vehicle's speed V2 after the calculation time task is V1 again, the vehicle's speed V2 is repeatedly calculated using Equations 4 and 5. If the vehicle's Δ moving distance is accumulated until the vehicle's speed V2 becomes 0, the first expected braking distance according to a specific expected braking force in current speed while driving can be calculated.

Furthermore, the intelligent vehicle management system 1000 according to an embodiment of the present invention includes the transmission/reception unit 600 configured to receive a brake signal and second expected braking distance information from the adjacent vehicle 50 during the driving of a vehicle being driven. The derivation unit 400 may derive the vehicle's expected braking force information required to secure a safe distance between the vehicle being driven and the adjacent vehicle 50 when the vehicle being driven is braked based on the first expected braking distance of the vehicle being driven and the brake signal and second expected braking distance of the adjacent vehicle 50 received through the transmission/reception unit 600. In this case, the transmission/reception unit 600 may also transmit the brake signal and first expected braking distance information of the vehicle being driven to the adjacent vehicle 50 or the intelligent vehicle management server 2000.

Furthermore, if braking is performed by a user's selection or if the adjacent vehicle 50, more specifically, the adjacent vehicle 50 ahead of a vehicle being driven is decelerated or braked, the control unit 500 may control the braking force of the vehicle being driven based on expected braking force information required to secure a safe distance between the vehicle being driven and the adjacent vehicle 50, which has been derived by the derivation unit 400 and which is required to brake the vehicle being driven.

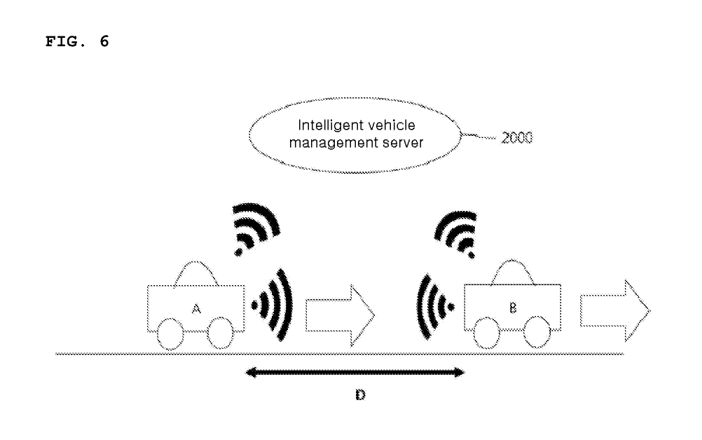

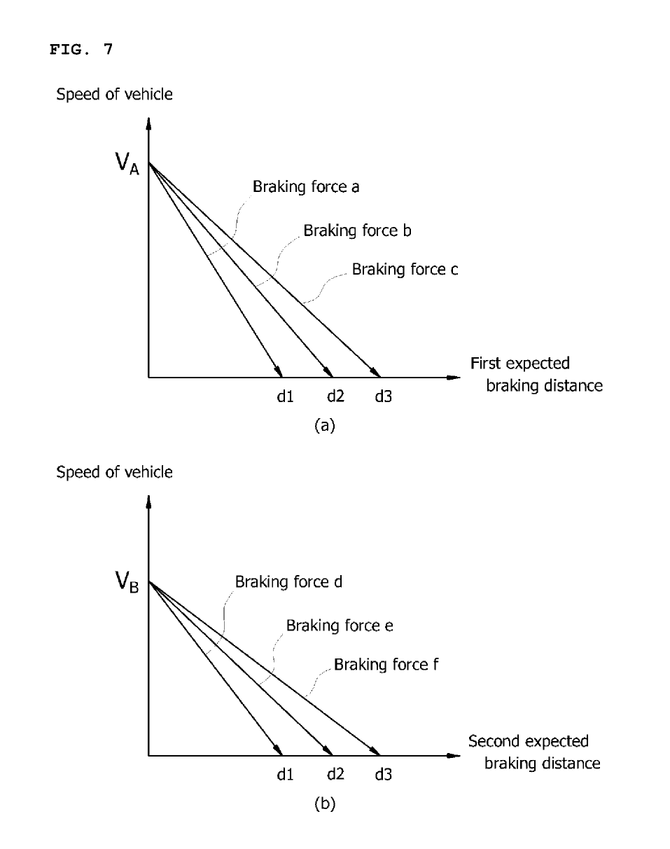

FIG. 6 is a conceptual diagram for illustrating the principle in which a safe distance between a vehicle A and an adjacent vehicle B can be maintained by the intelligent vehicle management system according to an embodiment of the present invention, and FIG. 7 is tables schematically showing the expected braking distances (e.g., a first expected braking distance and a second expected braking distance) of the vehicle A and the adjacent vehicle B depending on the speed and braking force of the vehicle A and the adjacent vehicle B.

Referring to FIG. 6, each of the vehicle A and the adjacent vehicle B has the intelligent vehicle management system 1000 mounted thereon. The vehicle A and the adjacent vehicle B may transmit and receive their braking forces or expected braking distances to and from a central server S capable of managing the intelligent vehicle management systems 1000 or may exchange the braking forces or the expected braking distance each other.

The adjacent vehicle B is being driven at a speed of VB, and the vehicle A behind the adjacent vehicle B is being driven at a speed of VA. In this case, the distance between the vehicle A and the adjacent vehicle B is assumed to be D.

Referring to FIG. 7(a), when the vehicle A being driven at the speed of VA is braked, the first expected braking distance may be different depending on an expected braking force. It is assumed that the first expected braking distances corresponding to a braking force “a”, a braking force “b”, and a braking force “c” are d1, d2, and d3, respectively.

Referring to FIG. 7(b), when the adjacent vehicle B being driven at the speed of VB is braked, the second expected braking distance may be different depending on an expected braking force. It is assumed that the second expected braking distances corresponding to a braking force “d”, a braking force “e”, and a braking force “f” are d1, d2, and d3, respectively.

If the adjacent vehicle B is braked by braking, the vehicle A receives the brake signal of the adjacent vehicle B and a second expected braking distance according to a current braking force from the adjacent vehicle B or the central server C. For example, if the adjacent vehicle B is braked by the braking force “c”, the vehicle A receives the second expected braking distance d3 according to the braking force “c.”

Furthermore, the derivation unit 400 of the vehicle A may calculate a first expected braking distance and an expected braking force corresponding to the first expected braking distance for maintaining a safe distance between the vehicle A and the vehicle B based on the second expected braking distance. For example, if the safe distance is the distance D between the vehicle A and the adjacent vehicle B when the second expected braking distance d3 is received, the first expected braking distance should be d3, and an expected braking force corresponding to the first expected braking distance d3 may be selected as the braking force “c.” In this case, the first expected braking distance may be calculated as d3−α, and the expected braking force may be calculated as the braking force “c”+P. In this case, α and β are positive numbers and very small correction values. The reason why −α is introduced into the first expected braking distance is to compensate for a time lag because there is the time lag between the time when the brake of the vehicle A is activated and the time when the second expected braking distance is received and the calculation time lag the first expected braking distance is calculated.

In this case, regardless of a force that a driver presses the brake in the case of a manned vehicle or in the case of a driverless vehicle, the control unit 500 may adjust brake line oil pressure so that a total braking force of the vehicle A tracks the braking force “c”, more specifically, the expected braking force “c”+β.

In the intelligent vehicle management system 1000 according to an embodiment of the present invention, the derivation unit 400 may derive the amount of regeneration energy which may be regenerated by the motor based on driving information for a vehicle and vehicle characteristic data in a deceleration situation. In this case, the derivation unit 400 may divide the deceleration situation of the vehicle into a natural coasting deceleration mode and a braking deceleration mode depending on whether a brake signal is activated or not.

A situation in which deceleration is performed due to various resistance while driving without a brake signal may be called the natural coasting deceleration mode. A deceleration situation in which braking is performed by a braking force in response to a brake signal may be called the braking deceleration mode.

In a hybrid vehicle or an electric vehicle, if the capacity of a motor is sufficient, energy which may be regenerated by the motor in a deceleration situation may converge on energy regenerated by the motor when deceleration is induced at a deceleration slope to the extent that a passenger may feel inconvenient. In other words, from a point of an extent at which available energy is produced, deceleration may be induced at an allowable deceleration slope capable of maximizing energy regeneration. However, as the amount of regeneration is increased, deceleration resistance applied to the vehicle is increased, making the deceleration slope sharp. As a result, a passenger may feel inconvenient. That is, if the deceleration slope becomes severe, a passenger may feel a deceleration impact as if he or she is pulled back by some huge force.

Accordingly, in the present embodiment, a deceleration slope of the extent at which that a passenger may not feel inconvenient is defined as a target deceleration slope. The target deceleration slope may be determined to be a deceleration slope that provides a feeling of proper deceleration through a coast deceleration test and a deceleration test according to a braking force in the development stage of a vehicle. In this case, the target deceleration slope is a function using at least a braking force as a variable, and the target deceleration slope in the natural coasting deceleration mode is a value when a braking force is 0.

The amount of regeneration energy calculated by the derivation unit 400 may be represented as follows depending on the deceleration mode.

1. In the case of natural coasting deceleration mode

The amount of regeneration energy=a value obtained by integrating {(a motor's target amount of power capable of generating a vehicle's target deceleration slope+γ)*motor efficiency} over time

2. In the case of braking deceleration mode

The amount of regeneration energy=a value obtained by integrating {(a motor's target amount of power capable of generating a vehicle's target deceleration slope+γ)*motor efficiency} over time or a value obtained by integrating the amount of regeneration energy={a demanded braking power loss*(1−a braking target energy loss rate+δ)*motor efficiency} over time

In this case, the demanded braking power loss may be calculated by multiplying a braking force N that is purely required according to a brake pedal stoke by a vehicle's speed (m/s), assuming that there is no energy regeneration resistance from the motor.

In this case, the braking target energy loss rate refers to a ratio of a braking force that is handled by a vehicle brake when the brake is activated and a braking force by motor regeneration. That is, the motor regeneration energy rate=1−a braking target energy loss rate. In this case, γ and δ are real numbers.

If γ and δ are positive values, it corresponds to a situation in which an actual deceleration slope is more steeply decelerated than a target deceleration slope. This means that more regeneration is performed compared to a case where deceleration is performed at the target deceleration slope. If γ and δ are negative values, it corresponds to a situation in which an actual deceleration slope is more gently decelerated than a target deceleration slope. This means that less regeneration is performed compared to a case where deceleration is performed at the target deceleration slope. If γ and δ are 0, it corresponds to a situation in which an actual deceleration slope is the same as a target deceleration slope. This means that regeneration is performed at the target deceleration slope.

The control unit 500 may add or subtract the amount of power generated by a motor or brake line oil pressure by performing feedback control (e.g., proportional control, differential control, or integral control) in which γ and δ converge on 0 using an equation for calculating the amount of regeneration energy so that an actual deceleration slope converges on a target deceleration slope. In other words, the control unit 500 may control a motor system for adding or subtracting the amount of power generated by a motor so that the amount of power generated by the motor converges on the target amount of power of the motor or may control a brake system using a method for adding or subtracting brake line oil pressure so that a braking loss energy rate converges on a braking target loss energy rate.

The intelligent vehicle management server 2000 capable of managing the intelligent vehicle management system 1000 according to an embodiment of the present invention may receive regeneration energy information or actual regeneration energy information in a deceleration situation from a plurality of vehicles on each of which the intelligent vehicle management system 1000 has been mounted, may store the reception information, and may use it as big data. In another case, pure regeneration energy which may be calculated using “regeneration energy−real energy consumed by a vehicle” may be used.

For example, the regeneration energy information or actual regeneration energy information of the vehicles which are collected and managed by the intelligent vehicle management server 2000 may be used to determine the power capacity of a power plant that is newly established. More specifically, a current plug-in electric vehicle or hybrid vehicle functions as only an entity to which power is supplied. If infrastructure in which a plug-in electric vehicle or hybrid vehicle can function as a supplier capable of supplying power to a power plant or a charging station is constructed, the power capacity of a power plant that is newly established may be determined by taking regeneration energy information or actual renewably energy information of a vehicle into consideration.

The intelligent vehicle management system 1000 according to an embodiment of the present invention may calculate may calculate fuel consumption or a fuel consumption rate for each element based on energy loss in each element through the operation unit 300, and may include a display unit 700 capable of displaying fuel consumption or a fuel consumption rate for each element. More specifically, the fuel consumption in each element may be calculated by dividing energy loss in each element by a fuel low-heating value. The fuel consumption rate of each element may be calculated by dividing energy loss of each element by total fuel consumption*a fuel low-heating value.

Furthermore, the calculation unit 300 may calculate at least fuel consumptions or a fuel consumption rates for transmission slip loss, rolling resistance loss, aerodynamic resistance loss, acceleration resistance loss and road gradient resistance loss over time or every driving cycle of a vehicle, may accumulate and statistically process the calculated values in real time or for a specific period, and may display the resulting values on the display unit 700.

In other words, the calculation unit 300 may calculate at least fuel consumptions or a fuel consumption rates for transmission slip loss, rolling resistance loss, aerodynamic resistance loss, acceleration resistance loss and road gradient resistance loss as real-time values and processed values by accumulating the at least one over time or every driving cycle through a vehicle. The value calculated by the calculation unit 300 may be all displayed on a screen of the display unit 700 or may be displayed for each element.

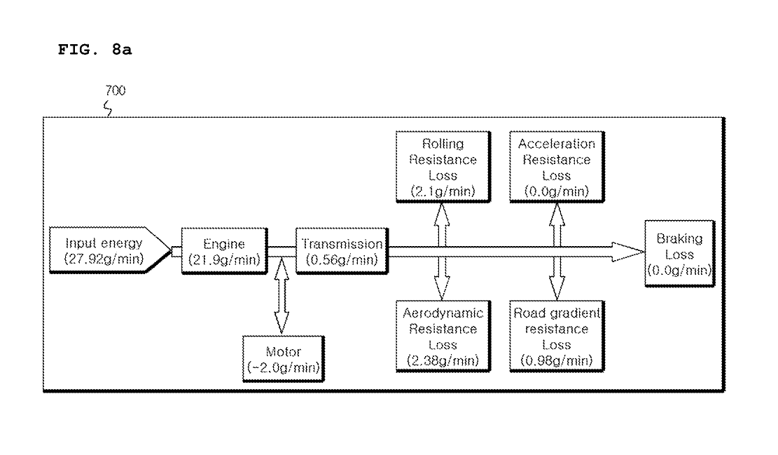

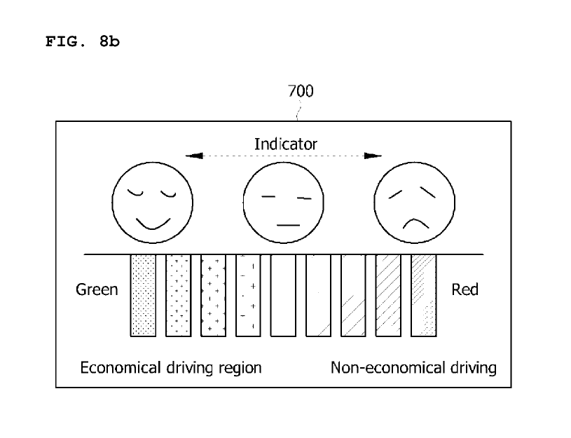

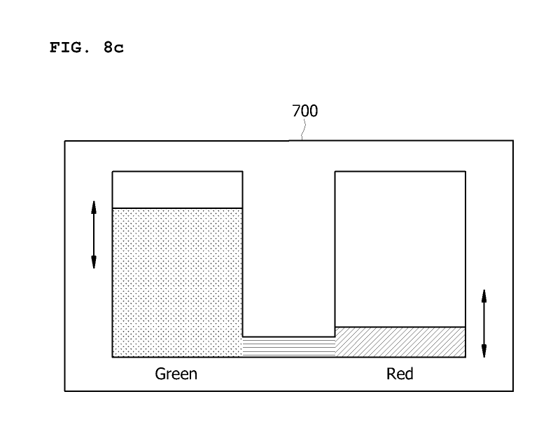

FIG. 8a is a diagram showing an example in which fuel consumption in each element is displayed on the display unit in accordance with an embodiment of the present invention, and FIGS. 8b and 8c are diagrams showing examples in which images changed according to an economic driving state are displayed on the display unit in accordance with an embodiment of the present invention.

Referring to FIG. 8a, the display unit 700 may display fuel consumption and a fuel consumption rate in each element using at least one of text, a number, a line, and an image.

That is, a factor that fuel consumption has suddenly increased may be displayed in an image form as shown in FIGS. 8b and 8c, for example, and provided to a driver. The factor may be displayed in a gauge form of various colors, such as blue, gray, or red.

Furthermore, the display unit 700 may include an LCD or LED panel buried in the dashboard of a vehicle, a head-up display (HUD), a wearable device, such as a smart watch, a smart phone, a tablet PC, a laptop, and a navigator, but the present invention is not necessarily limited thereto.

In other words, the display unit 700 may refer to an electronic device having a display function for displaying at least one of text, a number, a line, and an image.

The intelligent vehicle management system 1000 according to an embodiment of the present invention calculates fuel consumption or a fuel consumption rate in each element through the calculation unit 300, accumulates and statistically processes the calculated value in real time or in real time for a specific period or for a specific period, and provides the results to the display unit 700. Accordingly, economical driving can be induced because information about whether economical driving is performed is provided to a driver.

The intelligent vehicle management server 2000 capable of managing the intelligent vehicle management system 1000 according to an embodiment of the present invention may receive information about at least one of loss energy in each element, fuel consumption in each element, and a fuel consumption rate in each element from a plurality of vehicles on each of which the intelligent vehicle management system 10000 has been mounted, may store the reception information, and may use the stored information as big data. For example, if there is a system for imposing a fine or tax to a driver who has the driving habit of consuming lot of fuel consumption, a method for calculating an auto tax, including environmental charges, based on the energy (or fuel) consumption of a specific element or the combination of several elements for example, acceleration resistance energy loss (or acceleration resistance fuel consumption) lost due to acceleration resistance or aerodynamic resistance energy loss (or aerodynamic resistance fuel consumption) lost due to aerodynamic resistance and for imposing the calculated auto tax may be used apart from/in addition to the method of imposing a fine based on vehicle speed sensed by a speed gun.

In accordance with the intelligent vehicle management system 1000 according the present invention, the driving state of a vehicle can be derived and managed and the repair and maintenance of a vehicle can be induced or braking capable of securing a safe distance between vehicles can be controlled. Accordingly, the safety of vehicle driving can be significantly improved.

In accordance with the intelligent vehicle management system according to an embodiment of the present invention, whether a vehicle is normally controlled is derived. If, as a result of the derivation, abnormal control is determined to be derived, a warning signal is output to the vehicle in order to notify a driver of the necessity for repair and maintenance or the engine torque of the vehicle is limited. Accordingly, an accident attributable to abnormal control can be prevented.

Furthermore, the expected braking distance of a vehicle being driven is derived so that the control unit can control the vehicle. Accordingly, a safe distance between the vehicle and an adjacent vehicle can be secured.

Furthermore, the amount of potential regeneration energy when a vehicle is decelerated may be calculated and used as big data, or regeneration energy attributable to real deceleration may be used as big data. For example, if the amount of energy generated through a vehicle being driven is processed as big data and maintained, it may be useful to design the capacity of a related infrastructure facility, such as a power plant.

Furthermore, energy loss in each element can be calculated, processed, and used in various ways. For example, energy loss in each element can be displayed on a display screen so that a passenger may check the consumption of energy (or fuel) for each element in real time, and such data may also be used to design a system for imposing a tax based on the real consumption of fuel (this is proportional to CO2 emissions).

The aforementioned description is illustrative, and those skilled in the art to which the present invention pertains will appreciate that the present invention may be implemented in other detailed forms without departing from the technical spirit or essential characteristics of the present invention. Accordingly, the aforementioned embodiments should be construed as being only illustrative not as being restrictive from all aspects. For example, each of the elements described in the singular forms may be distributed and implemented. Likewise, elements described in a distributed way may also be combined and implemented.

The scope of the present invention is defined by the appended claims rather than the detailed description, and the present invention should be construed as covering all modifications or variations derived from the meaning and scope of the appended claims and their equivalents.

What is claimed is:

1. An intelligent vehicle management system, comprising:
a driving information collection unit configured to collect driving information about at least one of a brake pedal signal, an acceleration pedal opening degree, a virtual acceleration pedal opening degree, an autocruise switch signal, an engine RPM, a turbine RPM, a vehicle speed, instant fuel consumption, a road gradient, a motor current, a motor voltage, and atmospheric pressure for a vehicle;
a vehicle characteristic storage unit configured to store vehicle characteristic data regarding at least one of a torque converter characteristic curve (C-factor curve), a torque converter torque multiplication characteristic equation, vehicle weight, driving resistance, a gear ratio, a tire dynamic radius, friction torque for each gear, a braking force characteristics, an engine braking torque characteristic map for each gear, a braking target loss rate map, a motor efficiency map, powertrain system inertia, and a target deceleration slope for the vehicle;
an calculation unit configured to calculate energy loss in each of elements of the vehicle based on the driving information and the vehicle characteristic data; and
a derivation unit configured to derive information about at least one of whether the vehicle is normally controlled, an expected braking distance of the vehicle, and regeneration energy in a deceleration situation of the vehicle based on the driving information, the vehicle characteristic data, and at least one of the values calculated by the calculation unit.

2. The intelligent vehicle management system of claim 1, wherein:
the derivation unit sets a derivation mode of whether the vehicle is normally controlled as at least one of a first mode and a second mode based on the driving information about the vehicle,
the first mode is set when the driving information of the vehicle is determined to be at least acceleration driving or cruise driving, and
the second mode is set when the driving information of the vehicle is determined to be at least idle during a stop or idle during deceleration.

3. The intelligent vehicle management system of claim 2, wherein:
the derivation unit in the first mode derives whether the vehicle is normally controlled based on a difference between an energy value inputted from a driving source to a powertrain system and a sum of energy losses in elements subsequent to the driving source.

4. The intelligent vehicle management system of claim 3, wherein:
the vehicle is a mode in which an engine is driven in an internal-combustion engine vehicle or a hybrid vehicle, and
the driving source is an engine.

5. The intelligent vehicle management system of claim 3, wherein:
the vehicle is driven by only a motor in an electric vehicle or a hybrid vehicle, and
the driving source is a motor.

6. The intelligent vehicle management system of claim 2, wherein:
the derivation unit in the second mode calculates a value according to a second mode normal control reference equation based on the values calculated by the calculation unit and derives whether the vehicle is normally controlled.

7. The intelligent vehicle management system of claim 6, wherein:
the vehicle is a mode in which an engine is driven in an internal-combustion engine vehicle or a hybrid vehicle, and
the second mode normal control reference equation is represented to comprise at least transmission slip loss energy.

8. The intelligent vehicle management system of claim 6, wherein:
the vehicle is driven by only a motor in an electric vehicle or a hybrid vehicle, and the second mode normal control reference equation is represented to comprise at least acceleration resistance energy loss and road gradient driving energy loss.

9. The intelligent vehicle management system of claim 1, wherein the expected braking distance of the vehicle is derived by an expected braking distance reference equation represented to comprise at least rolling resistance, aerodynamic resistance, road gradient resistance, and an expected braking force of the vehicle.

10. The intelligent vehicle management system of claim 9, further comprising a transmission/reception unit configured to receive an expected braking distance of an adjacent vehicle from the adjacent vehicle or a specific server,
wherein the derivation unit derives expected braking force information required for braking based on the expected braking distance of the vehicle and an expected braking distance of an adjacent vehicle received through the transmission/reception unit.

11. The intelligent vehicle management system of claim 1, wherein:
the derivation unit sets derivation mode for regeneration energy information of the vehicle as at least one of a natural coasting deceleration mode and a braking deceleration mode based on the driving information of the vehicle,
the natural coasting deceleration mode is set when the driving information of the vehicle is determined to be decelerated due to driving resistance without a brake signal, and
the braking deceleration mode is set when the driving information of the vehicle is determined to be decelerated due to braking by a braking force.

12. The intelligent vehicle management system of claim 11, wherein the derivation unit in the natural coasting deceleration mode derives the regeneration energy information based on a target amount of power of a motor which is capable of generating the predetermined target deceleration slope.

13. The intelligent vehicle management system of claim 11, wherein the derivation unit in the braking deceleration mode derives the regeneration energy information based on at least one of a target amount of power of a motor and a braking target energy loss rate, which are capable of generating the predetermined target deceleration slope.

14. The intelligent vehicle management system of claim 12, further comprising a control unit configured to control a motor system so that an amount of power generated by the motor converges on the target amount of power of the motor or to control a brake system so that a braking energy loss rate converges on the braking target energy loss rate.

15. The intelligent vehicle management system comprising:
a driving information collection unit configured to collect driving information about at least one of a brake pedal signal, an acceleration pedal opening degree, a virtual acceleration pedal opening degree, an autocruise switch signal, an engine RPM, a turbine RPM, a vehicle speed, instant fuel consumption, a road gradient, a motor current, a motor voltage, and atmospheric pressure for a vehicle;
a vehicle characteristic storage unit configured to store vehicle characteristic data regarding at least one of a torque converter characteristic curve (C-factor curve), a torque converter torque multiplication characteristic equation, vehicle weight, driving resistance, a gear ratio, a tire dynamic radius, friction torque for each gear, a braking force characteristics, a motor efficiency map and powertrain system inertia;
A calculation unit configured to calculates at least fuel consumptions, energy consumptions or fuel consumption rates for transmission slip loss, rolling resistance loss, aerodynamic resistance loss, acceleration resistance loss and road gradient resistance loss based on the driving information and the vehicle characteristic data, and
a display unit configured to display the values calculated by the calculation unit in order to guide a driver to economical driving.

16. The intelligent vehicle management system comprising:
a driving information collection unit configured to collect driving information about at least one of a brake pedal signal, an acceleration pedal opening degree, a virtual acceleration pedal opening degree, an autocruise switch signal, a vehicle speed, a road gradient, a motor current, a motor voltage, and atmospheric pressure for a vehicle;
a vehicle characteristic storage unit configured to store vehicle characteristic data regarding at least one of vehicle weight, driving resistance, a gear ratio, a tire dynamic radius, friction torque for each gear, a braking force characteristics, a motor efficiency map and powertrain system inertia;
A calculation unit configured to calculate at least energy consumptions or energy consumption rates for rolling resistance loss, aerodynamic resistance loss, acceleration resistance loss and road gradient resistance loss based on the driving information and the vehicle characteristic data,
and
a display unit configured to display the values calculated by the calculation unit in order to guide a driver to economical driving,
wherein the vehicle is in a mode to be only driven by a motor in an electric vehicle or hybrid vehicle.

17. An intelligent vehicle management server, comprising:
a transmission/reception unit configured to receive reception information comprising driving information, vehicle characteristic data, and at least one of energy loss in each of elements of the vehicle;
a derivation unit configured to derive derivation information about at least one of whether the vehicle is normally controlled, an expected braking distance of the vehicle, and regeneration energy in a deceleration situation of the vehicle based on the reception information

18. The intelligent vehicle management server of claim 17, wherein:
the driving information is about at least one of a brake pedal signal, an acceleration pedal opening degree, a virtual acceleration pedal opening degree, an autocruise switch signal, an engine RPM, a turbine RPM, a vehicle speed, instant fuel consumption, a road gradient, a motor current, a motor voltage, and atmospheric pressure for a vehicle;
the vehicle characteristic data is regarding at least one of a torque converter characteristic curve (C-factor curve), a torque converter torque multiplication characteristic equation, vehicle weight, driving resistance, a gear ratio, a tire dynamic radius, friction torque for each gear, a braking force characteristics, an engine braking torque characteristic map for each gear, a braking target loss rate map, a motor efficiency map, powertrain system inertia, and a target deceleration slope for the vehicle;
the energy loss is calculated in each of elements of the vehicle based on the driving information and the vehicle characteristic data.

19. The intelligent vehicle management server of claim 18, wherein:
the transmission/reception unit receives the reception information from each of a plurality of vehicles, and
the derivation unit manages the derivation information.

20. The intelligent vehicle management server of claim 19, wherein the derivation unit derives a design of a power plant capacity or a calculation of an auto tax for environmental charges based on at least one of the reception information and the derivation information.
